(19) United States
(12) Patent Application Publication
(10) Pub. No.: US 2005/0252770 A1
(43) Pub. Date: Nov. 17, 2005

(54) Structure of gas sensor ensuring quick activation and mechanical strength

(75) Inventors: Susumu Naito, Kariya-shi (JP); Makoto Nakae, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/126,404

(22) Filed: May 11, 2005

(30) Foreign Application Priority Data
May 13, 2004 (JP) 2004-144086

(51) Int. Cl. G01N 27/26

(52) U.S. Cl. 204/424; 204/427

(57) ABSTRACT

A gas sensor element includes a solid electrolyte plate, a measurement gas-exposed and reference gas-exposed electrodes affixed the solid electrolyte plate to define a sensing portion, and a heater. The heater includes a heating element attached to a heater substrate in a given pattern which has a heating area S1. The solid electrolyte plate has a sensing area S2 in which the sensing portion is provided. The areas S1 and S2 are selected to meet a relation of S2/S1≦0.9, thereby ensuring the heating efficiency of the heater without sacrificing a minimum required size of the area S1 of the solid electrolyte plate or a desired mechanical strength of the gas sensor element.

### CROSS REFERENCE TO RELATED DOCUMENT

The present application claims the benefit of Japanese Patent Application No. 2004-144086 filed on May 13, 2004, the disclosure of which is incorporated herein by reference.

### BACKGROUND OF THE INVENTION

1. Technical Field of the Invention

The present invention relates generally to an improved structure of a gas sensor element which may be employed in combustion control for automotive internal combustion engines.

2. Background Art

There are known gas sensors such as A/F sensors installed in an exhaust system of automotive engines to measure the concentration of oxygen (O₂) contained in exhaust emissions for use in determining an air-fuel (A/F) ratio of mixture supplied to the engine for combustion feedback control in the engine (also called exhaust emission feedback control).

In such a control system, it is essential for enhancing the efficiency of purifying the exhaust gas using a three-way catalyst to bring an A/F ratio of mixture in a combustion chamber of the engine into agreement with a specific value.

For example, Japanese Patent First Publication No. 2000-65782 (U.S. Pat. No. 6,340,419 B1 assigned to the same assignee as that of this application) teaches a gas sensor element to be installed in a gas sensor for use in the above purpose. The gas sensor element consists of a solid electrolyte plate, a measurement gas-exposed electrode, and a reference gas-exposed electrode which are affixed to the solid electrolyte plate. The measurement gas-exposed electrode is opposed to the reference gas-exposed electrode through a portion of the solid electrolyte plate to define a sensing portion. The gas sensor element also includes a heater made up of a heater substrate joined to the solid electrolyte plate and a heating element affixed to the heater substrate.

There are also known oxygen sensors and NOx sensors for use in the above described exhaust emission feedback control. The oxygen sensors are designed to measure the concentration of O₂ contained in exhaust emissions of the engine. The NOx sensors are designed to measure the concentration of nitrogen oxides (NOx) that are air pollutants usually contained in exhaust emissions of the engine. Gas sensors of these types typically have installed therein an oxygen sensor element and a NOx sensor element which have a structure similar to the one, as disclosed in the above publication, and work to measure the concentration of O₂ and NOx, respectively.

In recent years, gas sensor elements of the above types have been required to be activated quickly and have a high measurement accuracy level. Particularly, the quick activation is effective in reducing HC emissions which are produced greatly at an initial stage of cold start of the engine and thus required to be enhanced further.

The quick activation may be achieved by increasing electrical power supplied to the heater of the gas sensor element at the cold start of the engine or decreasing the size of the gas sensor element itself to decrease a thermal capacity thereof. The former approach, however, will result in increased power consumption of the gas sensor element. The latter will result in reductions in ease of production and performance of the gas sensor element.

The heating element is typically made of a conductive line affixed to the heater substrate in a given pattern. The overall size of the pattern or width of the conductive line are being decreased with a decrease in overall size of the gas sensor element, thus resulting in an increase in resistance of the heating element which in turn leads to a need for decreasing electric power to be supplied to the heating element.

The above problem may be alleviated by increasing the size or thickness of the pattern of the conductive line of the heating element to decrease the resistance of the heating element. This approach, however, results in an increased possibility of electrical short of the conductive line which causes the resistance of the heating element to be decreased, so that the current flowing therethrough is increased or in any defect of the heating element contributing to mechanical breakage of the gas sensor element. This may be avoided by increasing the interval between adjacent segments of the conductive line, but resulting in an increased difficulty in decreasing the size of the heater.

Japanese Patent No. 3174059 (U.S. Pat. No. 5,756,971) teaches a multi-layered heater designed for the purpose of decreasing the width thereof. This, however, leads to concern about electromigration arising from an increased field intensity in the heater caused by the multi-layering as well as an overall increase in manufacturing cost of the gas sensor element.

Japanese Patent First Publication No. 2001-153835 (US 2003/0201193 A1 and U.S. Pat. No. 6,569,303 B1) teaches an improved structure of a gas sensor element designed to decrease an overall size thereof without sacrificing the size of a heater. The gas sensor element is illustrated at numeral 9 in FIG. 15.

The gas sensor element 9 includes a solid electrolyte plate 11, a measurement gas-exposed electrode 161, and a reference gas-exposed electrode 162. The measurement gas-exposed electrode 161 and the reference gas-exposed electrode 162 are affixed to the solid electrolyte plate 11 to define a sensing portion 16. The gas sensor element 9 also includes a heater 19 made up of a heater substrate 190 attached to the solid electrolyte plate 11 through a spacer 15 and a heating element 191 affixed to the heater substrate 190.

The measurement gas-exposed electrode 161 is exposed to a gas chamber 120 formed in a spacer 12. On the spacer 12, a porous layer 13 and a barrier layer 14 are laid.

The gas sensor element 9 has side surfaces 901 and 902 chamfered over the barrier layer 14, the porous layer 13, and the spacer 12 in order to have a compact structure.

The chamfering of the side surfaces 901 and 902 of the gas sensor element 9, however, has become insufficient to meet recent quick activation requirements. Efficient techniques for decreasing the size of the gas sensor element are, therefore, sought.

The decreasing of the size of the gas sensor element requires decreasing the thickness or width thereof as much as possible. Typically, the gas sensor element is made of ceramic. The decreasing of the size of the gas sensor element will, therefore, result in a decreased mechanical strength thereof.

### SUMMARY OF THE INVENTION

It is therefore a principal object of the invention to avoid the disadvantages of the prior art.

It is another object of the invention to provide an improved structure of a gas sensor element capable of being activated quickly without sacrificing the mechanical strength thereof.

According to one aspect of the invention, there is provided a gas sensor element which may be employed in an oxygen (O₂) sensor, a NOx sensor, an HC sensor, a CO sensor. The gas sensor element comprises: (a) a solid electrolyte plate; (b) a measurement gas-exposed electrode affixed to a surface of the solid electrolyte plate; (c) a reference gas-exposed electrode affixed to a surface of the solid electrolyte plate; (d) a sensing portion defined by the measurement gas-exposed electrode, the reference gas-exposed electrode, and a portion of the solid electrolyte plate through which the measurement gas-exposed electrode and the reference gas-exposed electrode are opposed to each other; and (e) a heater including a heater substrate joined to the solid electrolyte plate and a heating element affixed to the heater substrate in a preselected pattern. The pattern of the heating element occupies an area S1 on the heater substrate which is defined by a first, a second, a third, and a fourth line. The first and second lines extend in a width-wise direction of the gas sensor element through ends of the pattern in a lengthwise direction of the gas sensor element. The third and fourth lines extend in the lengthwise direction of the gas sensor element through ends of the pattern in the width-wise direction of the gas sensor element. The solid electrolyte plate has an area S2 defined by a fifth and a sixth line which extend in the width-wise direction of the gas sensor element through ends of the sensing portion in the longitudinal direction of the gas sensor element. The areas S1 and S2 are selected to meet a relation of S2/S1≦0.9. This permits the heating efficiency of the heater to be enhanced without sacrificing a minimum required size of the area S1 of the solid electrolyte plate.

In the preferred mode of the invention, the areas S1 and S2 may be selected to have a relation of 0.4≦S2/S1≦0.7. When the value of S2/S1 is smaller than 0.4, it results in an increase in overall width of the gas sensor element, thus leading to an increase in outer surface area thereof which may reduce the efficiency in heating the solid electrolyte plate by the heater. When the value of S2/S1 is greater than 0.7, it may result in a decrease in the efficiency in heating the solid electrolyte plate caused by a lower thermal conductivity thereof.

The gas sensor element may further include an alumina material disposed between the solid electrolyte plate and the heating element. The alumina is usually high in thermal conductivity, thus enhancing the transmission of thermal energy from the heater to the solid electrolyte plate to accelerate the activation of the gas sensor element.

The solid electrolyte plate and the heating substrate constitute a body of the gas sensor element which has a length with a sensing side end on which the sensing portion is provided and a sensor output side end opposed to the sensing side end. The sensing side end has a transverse sectional area smaller than that of the sensor output side end. This results in a decrease in size of the sensing side end, thus enhancing the quick activation of the gas sensor element. Usually, the sensor output side end is equipped with sensor output terminals and thus preferably greater in size for the purpose of ensuring electrical connections between the sensor output terminals and leads extending to an external sensor controller.

The body may have a transverse sectional area which increases continuously from the sensing side end toward the sensor output side end, thereby minimizing mechanical stress which arises from, for example, the moment applied to the sensing side end and acts on side surfaces of the body, causing the breakage of the gas sensor element.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a transverse sectional view which shows a gas sensor element according to the first embodiment of the invention;

FIG. 2 is an exploded perspective view which shows a gas sensor element of the first embodiment of the invention;

FIG. 3 is a partially plan view which shows a solid electrolyte plate of the gas sensor as illustrated in FIG. 2;

FIG. 4 is a partially plan view which shows a heater of the gas sensor as illustrated in FIG. 2;

FIG. 5 is a graph which shows experimental results representing a relation between an activation time an a value of S1/S2;

FIG. 6 is a partially transverse sectional view which shows a gas sensor element according to the second embodiment of the invention;

FIG. 7 is a partially transverse sectional view which shows a first modification of a gas sensor element of the second embodiment of the invention;

FIG. 8 is a partially transverse sectional view which shows a second modification of a gas sensor element of the second embodiment of the invention;

FIG. 9 is a partially transverse sectional view which shows a third modification of a gas sensor element of the second embodiment of the invention;

FIG. 10 is a partially transverse sectional view which shows a gas sensor element according to the third embodiment of the invention;

FIG. 11 is a partially transverse sectional view which shows a gas sensor element according to the fourth embodiment of the invention;

FIG. 12 is a sectional view taken along the line A-A in FIG. 11;

FIG. 13 is a partially transverse sectional view which shows a modification of a gas sensor element of the fourth embodiment of the invention;

FIG. 14(a) is a sectional view taken along the line B-B in FIG. 13;

FIG. 14(b) is a sectional view taken along the line C-C in FIG. 13;

FIG. 14(c) is a sectional view taken along the line D-D in FIG. 13; and

FIG. 15 is a transverse sectional view which shows a conventional gas sensor element.

### DESCRIPTION OF THE PREFERRED EMBODIMENTS

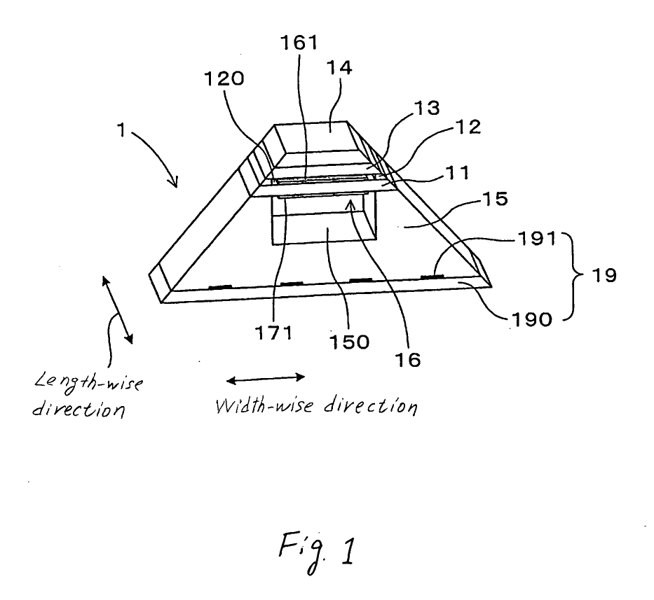

Referring to the drawings, wherein like reference numbers refer to like parts in several views, particularly to FIGS. 1 to 4, there is shown a multi-layered gas sensor element 1 according to the first embodiment of the invention which may be designed as an oxygen (O₂) sensor element, a NOx sensor element, an HC sensor element, or a CO sensor element to measure the concentration of O₂, NOx, HC, or CO contained in gasses, respectively. The gas sensor element 1 may alternatively be designed as an A/F (i.e., air-fuel ratio) sensor or the so-called λ-sensor which is to be installed in an exhaust pipe of an automotive internal combustion engine for controlling an air-fuel ratio of a mixture supplied to the engine in a feedback form. A gas sensor element of this type is usually installed in a hollow cylindrical housing to which a measurement gas-exposed cover and an air-exposed cover are joined and used as a gas sensor. The structure of such a gas sensor may be of any known type and explanation thereof in detail will be omitted here.

The gas sensor element 1 includes a solid electrolyte plate 11, a measurement gas-exposed electrode 161, and a reference gas-exposed electrode 171 which are affixed to opposed surfaces 118 and 119 of the solid electrolyte plate 11. The measurement gas-exposed electrode 161 and the reference gas-exposed electrode 171 face each other through a portion of the solid electrolyte plate 11 to define a sensing portion 16 which is sensitive to a gas to be measured (which will also be referred to as a measurement gas below) to produce a sensor output. The operation of the sensing portion 16 is well known in the art of the oxygen (O₂) sensor, the NOx sensor, the HC sensor, or the CO sensor, and explanation thereof in detail will be omitted here.

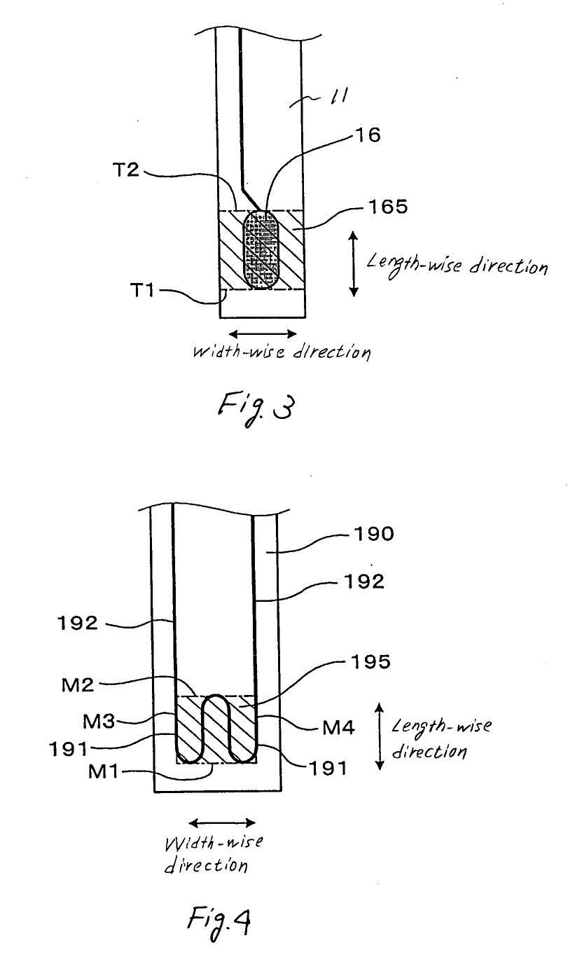

The gas sensor element 1 also includes a heater 19 made up of a heater substrate 190 and a heating element 191. The heating element 191 is, as clearly illustrated in FIG. 4, of a W-shape and affixed to the surface of the heater substrate 190 to define a heating region 195 which works to produce thermal energy for heating a body (i.e., the solid electrolyte plate 11) of the gas sensor element 1 up to a desired activation temperature. The heating region 195 has an area S1 defined by lines M1, M2, M3, and M4. The lines M1 and M2 extend in a width-wise direction of the heater substrate 190 (i.e., a width-wise direction of the gas sensor element 1) through outside end or edges and an inside edge of the heating element 191, respectively. The lines M3 and M4 extend in a longitudinal direction of the heater substrate 190 (i.e., a longitudinal direction of the gas sensor element 1) through outer sides of the heating element 191. The solid electrolyte plate 11, as clearly illustrated in FIG. 3, has a sensor region 165 in which the sensing portion 16 is provided and defined by lines T1 and T2. The lines T1 and T2 extend in a width-wise direction of the solid electrolyte plate 11 (i.e., the width-wise direction of the gas sensor element 1) through an outside and an inside edge of the sensing portion 16 located at an outer side and an inner side of the solid electrolyte plate 11 in the lengthwise direction of the solid electrolyte plate 11, respectively. The sensor region 165 has an area S2 which has a relation of S2/S1≦0.9.

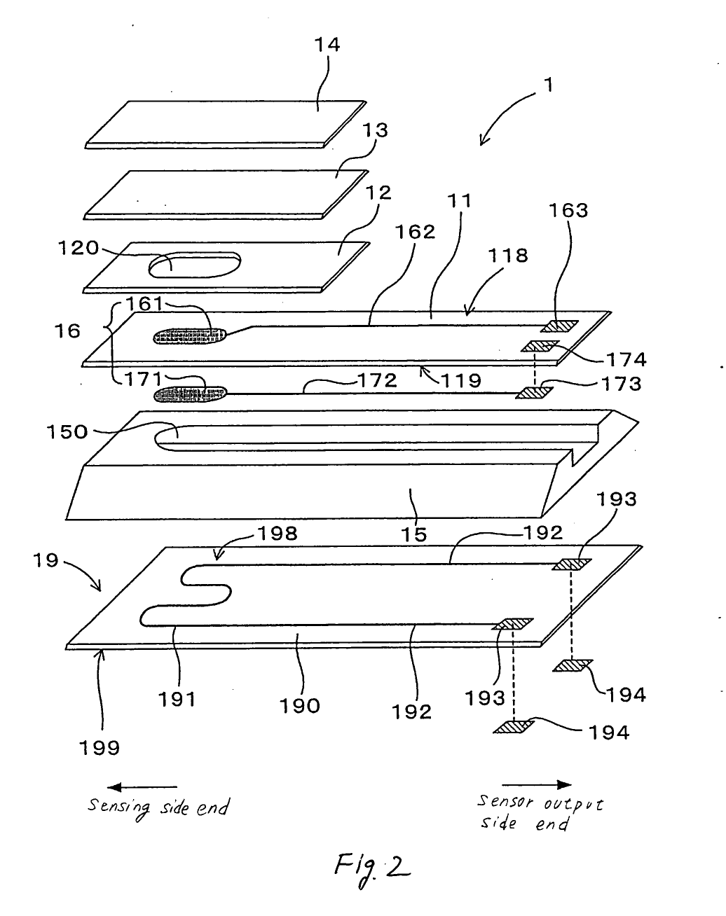

Referring back to FIGS. 1 and 2, the gas sensor element 1 is made of a lamination consisting of the heater 19, a spacer 15, the solid electrolyte plate 11, a spacer 12, a porous layer 13, and a barrier layer 14. The spacer 15 is affixed to the heater substrate 190 and the surface 119 of the solid electrolyte plate 11. The spacer 12 is affixed to the surface 118 of the solid electrolyte plate 11. The porous layer 13 is affixed to the spacer 12. The barrier layer 14 is affixed to the porous layer 13.

The solid electrolyte plate 11 is made of an oxygen ion conductive zirconia ceramic such as a partially stabilized zirconia containing yttria. The barrier layer 14, the porous layer 13, the spacers 12 and 15, and the heater substrate 190 are each made of an insulating ceramic such as alumina. The porous layer 13 is permeable to gas, while the others are impermeable to gas. The spacer 12 has formed therein a window which defines a measurement gas chamber 120 together with the solid electrolyte plate 11 and the porous layer 13 into which gas to be measured is admitted. The spacer 15 has a groove elongated in the lengthwise direction thereof which defines a reference gas chamber 150 together with the solid electrolyte plate 11 into which air is admitted as a reference gas.

On the surface 118 of the solid electrolyte plate 11, terminals 163 and 174 and a lead 162 are formed. The terminal 163 electrically connects with the measurement gas-exposed electrode 161 through the lead 162. On the surface 119, an inner terminal 173 and a lead 172 are formed. The inner terminal 173 electrically connects with the reference gas-exposed electrode 171 through the lead 172. The inner terminal 173 electrically connects with the terminal 174 on the surface 118 through a conductive hole (not shown) extending through the thickness of the solid electrolyte plate 11. The terminals 163 and 174 are to be joined to leads (not shown) retained in the gas sensor for transmitting a sensor output to an external control circuit (not shown).

On the surface 198 of the heater substrate 190 facing the spacer 15, inner terminals 193 and leads 192 are formed. The leads 192 electrically connect with the heating element 191 through the leads 192. The inner terminals 193 electrically connect with outer terminals 194 affixed to the surface 199 of the heater substrate 190 through conductive holes (not shown) extending through the thickness of the heater substrate 190, respectively. The heating element 191 and the leads 192 are made of a conductive line extending from one of the inner terminals 193 to the other along the periphery of the surface 198 in the lengthwise direction of the heater substrate 190.

In the following discussion, an end of the length of the gas sensor element 1 on which the sensing portion 16 is provided will also be referred to below as a sensing side end. The other end will also be referred to below as a sensor output side end. The inner terminals 173 and 193 and the terminal 163, 174, and 194 are located on the sensor output side end.

The sensor output is produced by the sensing portion 16 made by the measurement gas-exposed electrode 161 and the reference gas-exposed electrode 171 facing each other through the solid electrolyte plate 11. The solid electrolyte plate 11, as described above with reference to FIG. 3, has the sensor region 165 defined by the lines T1 and T2 extending perpendicular to the length of the solid electrolyte plate 11 (i.e., the length of the gas sensor element 1) through the outermost edges of the sensing portion 16 aligned in the lengthwise direction of the solid electrolyte plate 11 and the sides of the solid electrolyte plate 11. The surfaces 118 and 119 of the solid electrolyte plate 11 may have widths different from each other. In this case, the sensor region 165 is defined by sides of one of the surfaces 118 and 119 having the smaller width.

The heater substrate 190, as described above with reference to FIG. 4, has the heating region 195 which is encompassed by the heating element 191. In other words, the heating region 195 is an area on the heater substrate 190 occupied by the pattern of the heating element 191. Specifically, the heating region 195 is defined by the lines M1 and M2 extending perpendicular to the length of the heater substrate 190 (i.e., the length of the gas sensor element 1) through outer and inner ends of the pattern and the lines M3 and M4 extending parallel to the length of the heater substrate 190 (i.e., the longitudinal center line of the gas sensor element 1) through the sides of the pattern.

The gas sensor element 1 is, as clearly shown in FIG. 1, trapezoidal in a transverse cross section and has the smallest width at the barrier layer 14 and the largest width at the heater substrate 190. The area S1 of the heating region 195 and the area S2 of the sensor region 165 in which the sensing portion 16 is provided bears the relation of S2/S1≦0.9, and preferably 0.4≦S2/S1≦0.7, thereby permitting the heating efficiency of the heater 19 to be enhanced without sacrificing a minimum required area of the sensor region 165.

The solid electrolyte plate 11 is, as described above, made of zirconia ceramic. The barrier layer 14, the porous layer 13, the spacers 12 and 15, and the heater substrate 190 are each made of alumina. The zirconia is usually lower in breaking strength and thermal conductivity than the alumina. The above relation between the areas S1 and S2, thus, permitting occupancy of zirconia (i.e., the solid electrolyte plate 11) in the gas sensor element 1 to be decreased to minimize breakage of the gas sensor element 1 caused by thermal stress increasing with a decrease in temperature distribution within the gas sensor element 1 arising from a decreased size of the solid electrolyte plate 11.

We measured the times required for activating the gas sensor element 1 and the gas sensor element 9, as described in the introductory part of this application with reference to FIG. 15, which has the side surfaces 901 and 902 chamfered from the barrier layer 14 to the spacer 12. The gas sensor element 1 and the gas sensor element 9 are made of the same material and identical in thickness of each layer. The gas sensor elements 1 and 9 are also identical in width of the surface 199 of the heater substrate 190 and area of the heating region 195 in which the heating element 191 is disposed with each other. The heating region 195 of the gas sensor element 9 is, however, greater than that of the gas sensor element 9 and has a relation of S2/S1>0.9.

We supplied the same power to the heating elements 191 of the gas sensor elements 1 and 9 from the same power supply and found that 3.5 seconds are required to elevate the temperature of the sensor region 165 of the gas sensor element 1 up to 700° C., while 6 seconds are required by the gas sensor element 9. Note that 700° C. is the temperature required to activate each of the gas sensor elements 1 and 9 in order to produce a sensor output correctly as a function of concentration of gas to be measured.

We also prepare samples of the gas sensor element 1 having different values of S2/S1 and measured the times required to activate the samples in the same manner as described above. Results of the above measurements are demonstrated in a graph of FIG. 5. The graph shows that when the value of S2/S1 exceeds 0.9, it results in a great increase in the activation time, while when the value of S2/S1 is smaller than 0.7, it ensures the stability of activation of the gas sensor element 1 within a short period of time.

As apparent from the above, the structure of the gas sensor element 1 of this embodiment permits the size of the solid electrolyte plate 11 to be decreased as compared with the overall size of the gas sensor element 1 without sacrificing the heating efficiency of the heating element 191, thereby resulting in a decreased activation time of the gas sensor element 1.

The heating region 195 is greater in area than the sensor region 165, thus permitting an increase in resistance of the heating element 191 arising from a decrease in size thereof to be reduced. This alleviates the limitation of power supply to the heater 19.

Usually, the thermal conductivity of alumina is ten (10) times greater than that of zirconia. The use of the alimina-made spacer 15 between the solid electrolyte plate 11 and the heater substrate 190, therefore, results in a further increase in the heating efficiency of the heating element 191.

The structure of the gas sensor element 1 permits the overall size thereof to be decreased by reducing the size of the solid electrolyte plate 11 without sacrificing the size of the heater 19, thereby ensuring a minimum reduction in overall mechanical strength of the gas sensor element 1.

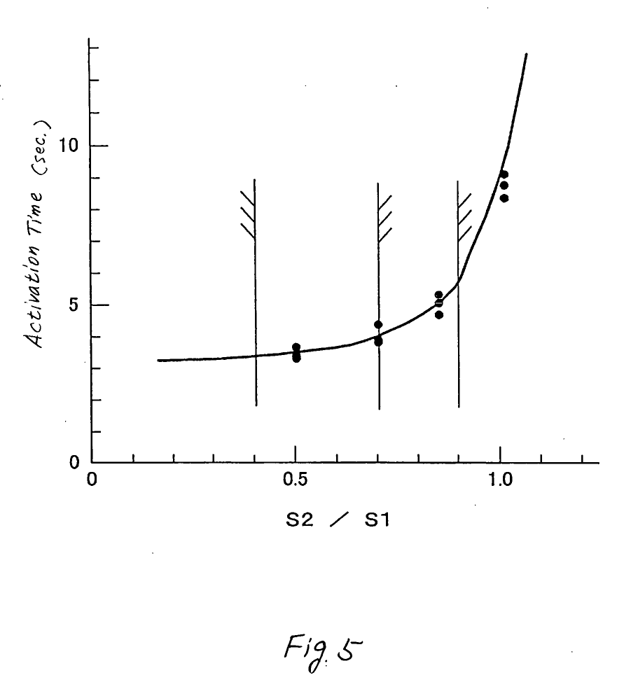

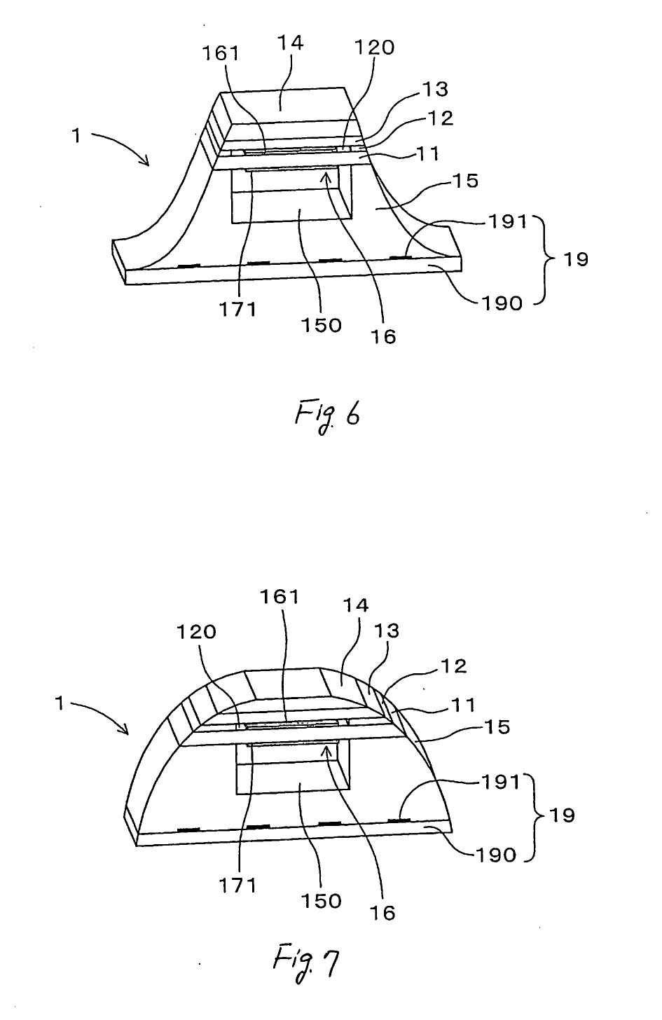

FIGS. 6 to 9 show gas sensor elements 1 according to the second embodiment of the invention which are designed to meet, like the first embodiment, the relation of S2/S1≦0.9, but different in external configuration from the first embodiment.

Each of the gas sensor elements 1, as illustrated in FIGS. 6 to 9, is made of a lamination of the heater substrate 190, the spacer 15, the solid electrolyte plate 11, the spacer 12, the porous layer 13, and the barrier layer 14.

The gas sensor element 1 of FIG. 6 is trapezoidal in a transverse cross section with curved sides. The gas sensor element 1 of FIG. 7 is semicircular in a transverse cross section. The gas sensor element 1 of FIG. 8 has a smaller width from the barrier layer 14 to the solid electrolyte plate 11 and a greater width from the spacer 15 to the heater substrate 190. The gas sensor element 1 of FIG. 9 is basically identical in overall shape with the one of the first embodiment, but different therefrom in that the heater substrate 190 is chamfered so that the width thereof decreases as reaching the bottom (i.e., a lower side of the drawing).

Other arrangements and operation of each of the gas sensor elements 1 are identical with those in the first embodiment, and explanation thereof in detail will be omitted here.

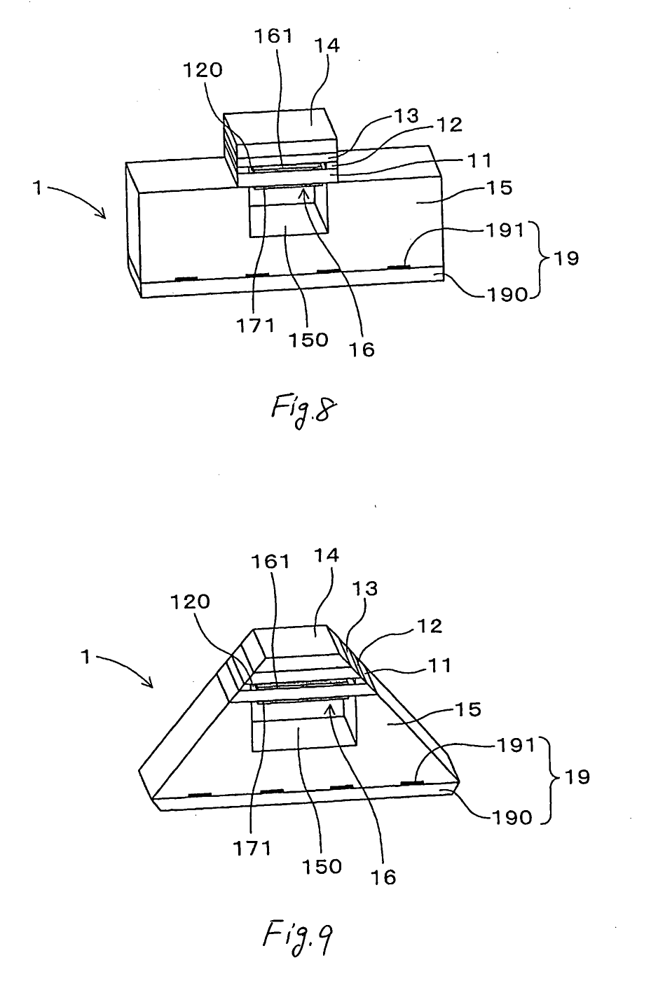

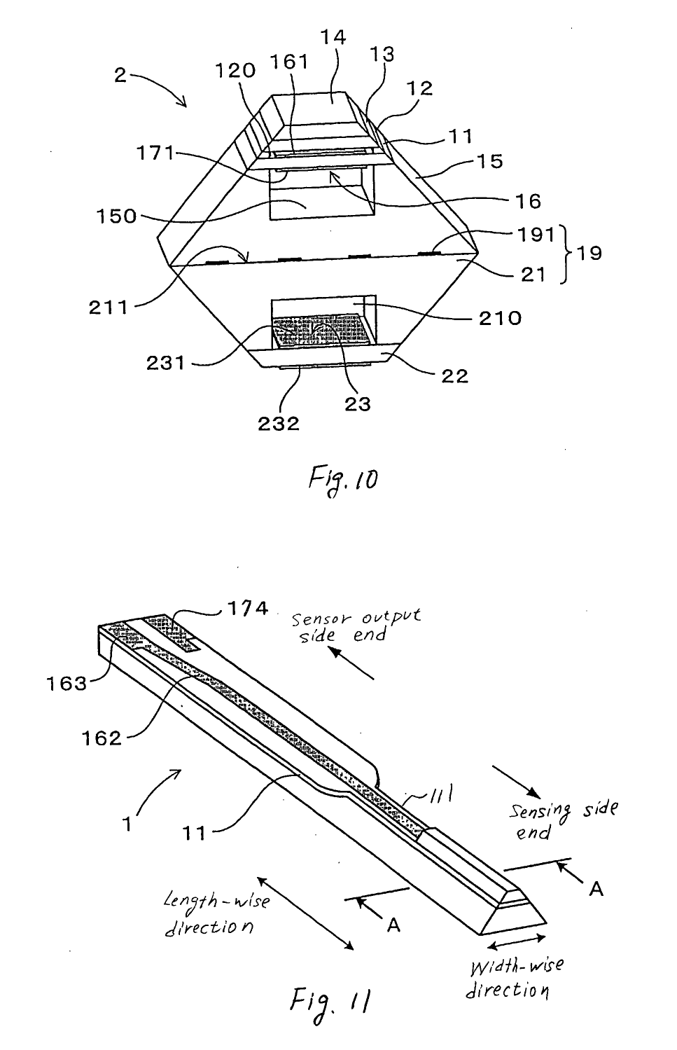

FIG. 10 shows a gas sensor element 2 according to the third embodiment of the invention which is designed to have two sensing portions.

Specifically, the gas sensor element 2 consists of the barrier layer 14, the porous layer 13, the spacer 12, the solid electrolyte plate 11, the spacers 15 and 21, and the solid electrolyte plate 22.

The solid electrolyte plate 11 has the measurement gas-exposed electrode 161 and the reference gas-exposed electrode 171 affixed thereto. The measurement gas-exposed electrode 161 is exposed to the gas chamber 120 formed in the spacer 12 into which the measurement gas is admitted. The reference gas-exposed electrode 171 is exposed to the reference gas chamber 150 formed in the spacer 15 into which air is admitted as the reference gas. The solid electrolyte plate 22 has the reference gas-exposed electrode 231 and the measurement gas-exposed electrode 232 affixed thereto. The reference gas-exposed electrode 231 is exposed to the reference gas chamber 210 formed in the spacer 21 to which air is admitted as the reference gas. The measurement gas-exposed electrode 232 is to be exposed directly to the measurement gas.

The heater 19 is made up of the heating element 191 and the spacer 21. The spacer 21 is used as a heater substrate. The heating element 191 is interposed between the spacers 15 and 21.

The gas sensor element 2 includes two sensing portions 16 and 23. The sensing portion 16 is defined by the measurement gas-exposed electrode 161, the reference gas-exposed electrode 171, a portion of the solid electrolyte plate 11 through which the electrodes 161 and 171 face each other. The sensing portion 23 is defined by the measurement gas-exposed electrode 232, the reference gas-exposed electrode 231, a portion of the solid electrolyte plate 22 through which the electrodes 231 and 232 face each other.

Each of the sensing portions 16 and 23 has the same sensor region as that of the first embodiment illustrated in FIG. 3. The sensor region has the area S2 defined in the same manner as described in the first embodiment.

The heating element 191 are affixed to the surface 211 of the spacer 21, for example, in the same pattern as that in the first embodiment to have a heating region, like the one illustrated in FIG. 4. The heating region has the area S1 which is defined in the same manner as described in the first embodiment and meets the relation of S2/S1≦0.9.

Other arrangements and operation are identical with those in the first embodiment, and explanation thereof in detail will be omitted here.

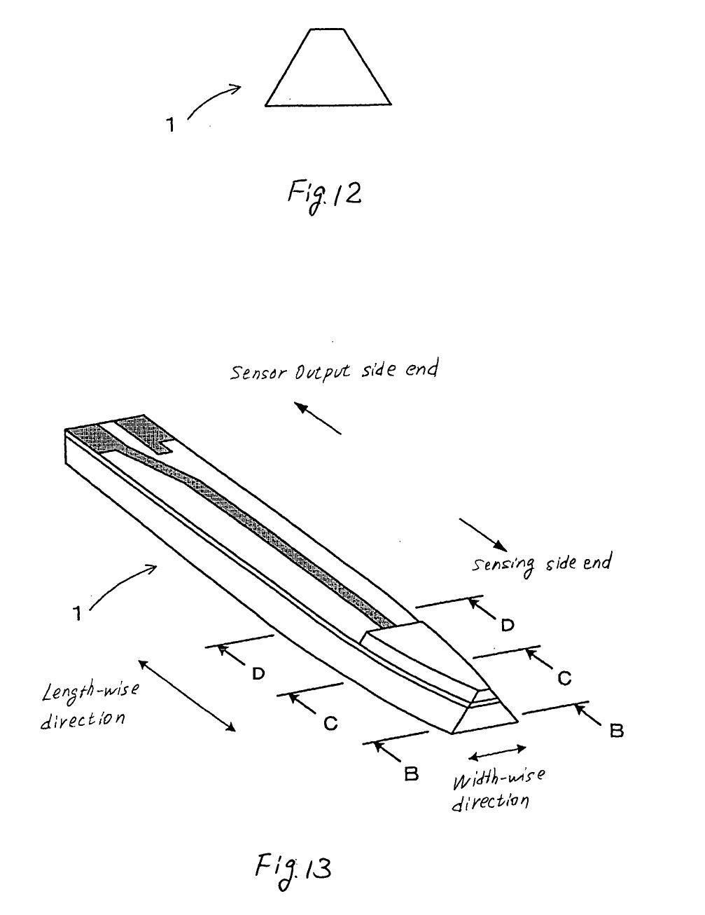

FIGS. 11 and 12 show the gas sensor element 1 according to the fourth embodiment of the invention which is different from the first embodiment only in that the solid electrolyte plate 11 has a narrow width portion 111 on which the sensor region (not shown) is defined.

Specifically, the narrow width portion 111 extends from the middle of the length of the gas sensor element 1 to the end thereof and has, as can be seen from FIG. 12, a trapezoidal shape in a transverse cross section which is substantially the same as illustrated in FIG. 1. The details thereof will be omitted here.

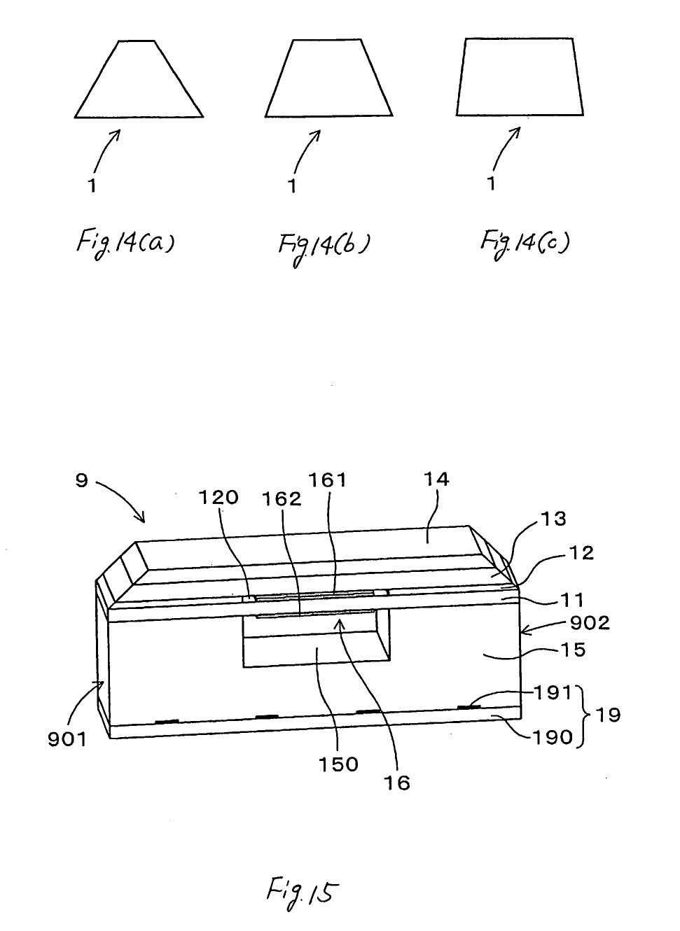

FIGS. 13 and 14(a) to 14(c) show a modification of the gas sensor element 1 of the fourth embodiment which is designed to have a length increasing in width continuously from the sensing end-side to the middle thereof. In other words, the gas sensor element 1 tapers toward the sensing end-side thereof.

The gas sensor element 1 has, as illustrated in FIG. 14(a), the same trapezoidal shape in a transverse cross section as that in the first embodiment at the top end of the sensing end-side, a trapezoidal shape, as illustrated in FIG. 14(b), with an upper base slightly longer than that in FIG. 14(a) in a transverse cross section located at a given distance away from the top end, and a substantially rectangular shape, as illustrated in FIG. 14(c), in a transverse cross section located at a given distance away from the one in FIG. 14(b).

The gas sensor element 1 of this modification has the same heating region and sensor region as those in the first embodiment which bear the relation of S2/S1≦0.9.

Other arrangements and operation of the gas sensor element 1 are identical with those in the first embodiment, and explanation thereof in detail will be omitted here.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

1. A gas sensor element having a length comprising:
a solid electrolyte plate;
a measurement gas-exposed electrode affixed to a surface of said solid electrolyte plate;
a reference gas-exposed electrode affixed to a surface of said solid electrolyte plate;
a sensing portion defined by said measurement gas-exposed electrode, said reference gas-exposed electrode, and a portion of said solid electrolyte plate through which said measurement gas-exposed electrode and said reference gas-exposed electrode are opposed to each other; and
a heater including a heater substrate joined to said solid electrolyte plate and a heating element affixed to the heater substrate in a preselected pattern,
wherein the pattern of the heating element occupies an area S1 on the heater substrate which is defined by a first, a second, a third, and a fourth line, the first and second lines extending in a width-wise direction of the gas sensor element through ends of the pattern in a lengthwise direction of the gas sensor element, the third and fourth lines extending in the lengthwise direction of the gas sensor element through ends of the pattern in the width-wise direction of the gas sensor element,
and wherein said solid electrolyte plate has an area S2 defined by a fifth and a sixth line which extend in the width-wise direction of the gas sensor element through ends of said sensing portion in the longitudinal direction of the gas sensor element, the areas S1 and S2 being selected to meet a relation of S2/S1≦0.9.

2. A gas sensor element as set forth in claim 1, wherein the areas S1 and S2 are selected to have a relation of 0.4≦S2/S1≦0.7.

3. A gas sensor element as set forth in claim 1, further comprising an alumina material disposed between said solid electrolyte plate and the heating element.

4. A gas sensor element as set forth in claim 1, wherein said solid electrolyte plate and the heating substrate constitute a body of the gas sensor element which has a length with a sensing side end on which said sensing portion is provided and a sensor output side end opposed to the sensing side end, and wherein the sensing side end has a transverse sectional area smaller than that of the sensor output side end.

5. A gas sensor element as set forth in claim 4, wherein the body has a transverse sectional area which increases continuously from the sensing side end toward the sensor output side end.
